(19) United States
(12) Patent Application Publication
(10) Pub. No.: US 2021/0222849 A1
(43) Pub. Date: Jul. 22, 2021

(54) OPTICAL ELEMENT, VEHICLE FRONT LAMP, LIGHT SOURCE DEVICE, AND PROJECTION DEVICE

(71) Applicant: SHARP KABUSHIKI KAISHA, Sakai City, Osaka (JP)

(72) Inventors: HIDEOMI YUI, Sakai City, Osaka (JP); SHIGERU AOMORI, Sakai City, Osaka (JP); MUTSUKO YAMAMOTO, Sakai City, Osaka (JP); TORU KANNO, Sakai City, Osaka (JP); TOMOKO UEKI, Sakai City, Osaka (JP)

(21) Appl. No.: 17/059,105

(22) PCT Filed: May 31, 2019
(86) PCT No.: PCT/JP2019/021675

§ 371 Date: Nov. 25, 2020

(30) Foreign Application Priority Data
May 31, 2018 (JP) 2018-104903

(51) Int. Cl. F21S 41/176; F21S 41/32; G02B 26/00

(52) U.S. Cl. CPC F21S 41/176; G02B 26/008; F21S 41/321

(57) ABSTRACT

Energy density of excitation light for irradiation is adjusted to achieve an improvement in fluorescent light emission intensity. An optical element includes a phosphor layer configured to emit fluorescent light by being excited by excitation light emitted from a light source, the phosphor layer has a first surface to be irradiated with the excitation light, an excitation light irradiation region of the first surface includes a first region and a second region, the first region is processed beforehand to be set at an angle that is not perpendicular to a propagation direction of the excitation light, and the first region and the second region are non-parallel to each other.

### TECHNICAL FIELD

The present invention relates to optical elements used in a light source device, a vehicle front lamp (vehicle headlight device), the light source device, and a projection device.

The present application claims priority to JP 2018-104903 filed in Japan on May 31, 2018, of which contents are incorporated herein by reference.

### BACKGROUND ART

It is known as prior art that a phosphor emits fluorescence in a case where an excitation light such as a blue laser is irradiated onto the phosphor.

### CITATION LIST

### Patent Literature

PTL 1: JP 2012-3267 A (published on Jan. 5, 2012)

### SUMMARY OF INVENTION

### Technical Problem

However, the prior art described above has a problem that temperature quenching occurs due to the heat generated when high energy density excitation light is incident on a phosphor. In other words, there is a problem in that the desired fluorescent light emission intensity cannot be obtained during high power irradiation in a case where the phosphor emits light by a blue laser or the like.

An aspect of the present invention has been conceived in view of the problems described above, and an object thereof is to adjust the energy density of the excitation light to be irradiated, and to achieve an improvement in fluorescent light emission intensity.

### Solution to Problem

In order to solve the above-described problems, an optical element according to an aspect of the present invention includes a phosphor layer configured to emit fluorescent light by being excited by excitation light emitted from a light source, the phosphor layer has a first surface to be irradiated with the excitation light, an excitation light irradiation region of the first surface includes a first region and a second region, the first region is processed beforehand to be set at an angle that is not perpendicular to a propagation direction of the excitation light, and the first region and the second region are configured to be non-parallel to each other.

### Advantage Effects of Invention

According to an aspect of the present invention, in comparison with a case where a phosphor surface is flat, irradiation energy density decreases due to an increase in irradiation area of the irradiation region, and an effect of preventing a drop in light emission efficiency from occurring due to the excitation energy density dependency may be exhibited.

According to an aspect of the present invention, it is possible to adjust the energy density of the excitation light to be irradiated onto the phosphor layer, and contribute to an improvement in fluorescent light emission intensity.

### BRIEF DESCRIPTION OF DRAWINGS

FIG. 1 is a schematic diagram illustrating a wavelength conversion element according to a prior art.

FIG. 2 is a graph illustrating energy density dependency of peak intensity of a YAG:Ce phosphor.

FIG. 3 is a schematic diagram illustrating an optical element according to a first embodiment of the present invention.

FIG. 4 is a schematic diagram illustrating an optical element according to a second embodiment of the present invention.

FIG. 5 is a schematic diagram illustrating an optical element according to a third embodiment of the present invention.

FIG. 6 is a schematic diagram illustrating beam characteristics of excitation light according to a fourth embodiment of the present invention.

FIG. 7 is a schematic diagram illustrating an optical element according to the fourth embodiment of the present invention.

FIG. 8 is a schematic diagram illustrating a light source device according to a fifth embodiment of the present invention.

FIG. 9 is a schematic diagram illustrating a light source device according to a sixth embodiment of the present invention.

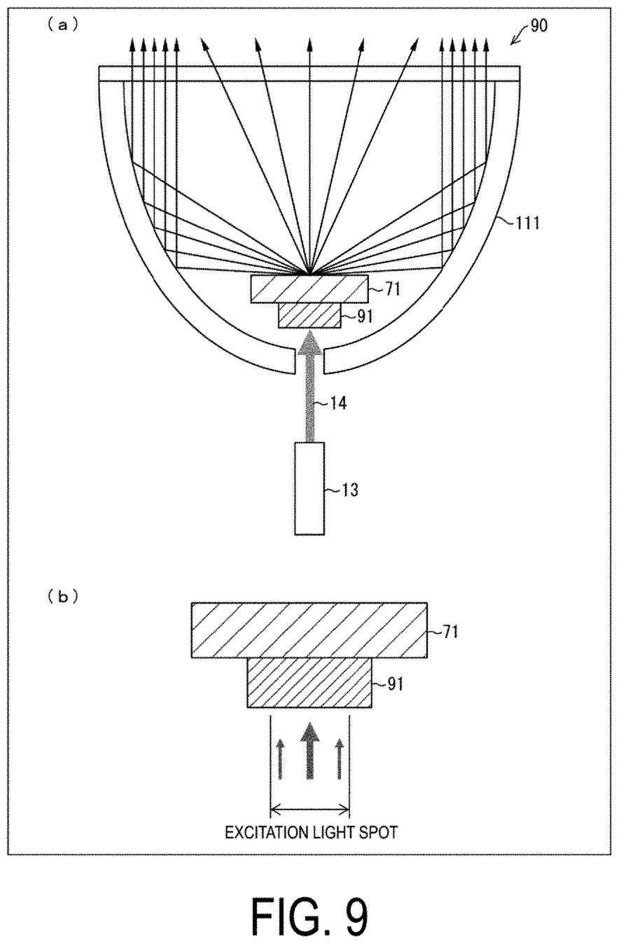

FIG. 10 is a schematic diagram illustrating a light source module according to a seventh embodiment of the present invention.

FIG. 11 is a schematic diagram illustrating a light source module according to the seventh embodiment of the present invention.

### DESCRIPTION OF EMBODIMENTS

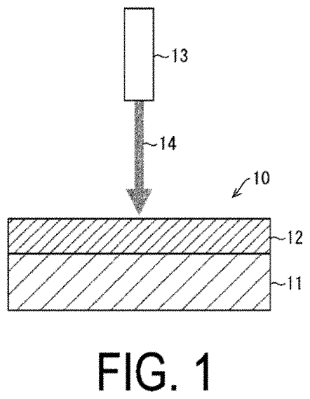

FIG. 1 illustrates a configuration of a general wavelength conversion element 10. A configuration in which a phosphor layer 12 is deposited on a substrate 11 is common. In a reflection-type optical system, the phosphor layer 12 is irradiated with excitation light 14 emitted from an excitation light source 13, and then the phosphor layer 12 fluoresces. There is a problem that the desired fluorescent light emission intensity cannot be obtained during high power irradiation in a case where a phosphor emits light by a blue laser or the like. That is, it is necessary to consider irradiation energy density dependency of light emission efficiency of the phosphor.

### Irradiation Energy Density Dependency of Light Emission Efficiency

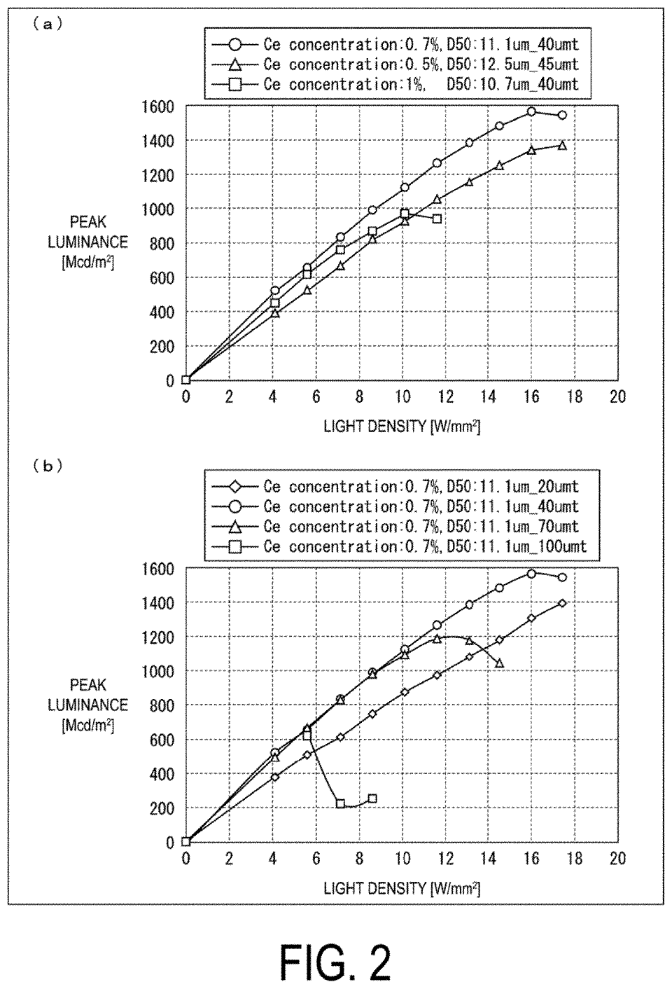

The irradiation energy density dependency of the light emission efficiency of the phosphor is described below based on external quantum efficiency of a YAG:Ce phosphor. As illustrated in FIG. 2(a), it can be seen that, for a phosphor material doped with Ce (cerium) as a dopant in YAG (yttrium aluminum garnet), the irradiation energy density dependency of the light emission efficiency differs depending on a difference in doping concentration of Ce.

In a case where the phosphor is irradiated with excitation light, the fluorescent light emission is obtained, and at the same time, part of the excitation light is converted to thermal energy, and thus the irradiation spot portion of the phosphor has high temperature. Thermal radiation can generally be described by the following equation.

Q=A·ϵ·σ·(T_{A}⁴−T_{B}⁴)

Here, Q represents an amount of radiant heat, A represents an area of a radiant portion, ϵ represents emissivity, σ represents the Stefan-Boltzmann constant, T_{A} represents the temperature of the radiant portion, and T_{B} represents the ambient temperature.

It is known that the light emission efficiency of a phosphor is affected by the temperature of the phosphor, and as illustrated in FIG. 2(a), the light emission efficiency decreases as the irradiation energy density increases. In order to obtain a stronger (brighter) fluorescent light emission, the irradiation intensity of the excitation light 14 needs to be increased, and in this case, increase of the temperature of the phosphor layer 12 may not be sufficiently suppressed depending on the cooling condition.

It is also known that temperature characteristics of a phosphor vary depending on the concentration of a light emission center element (Ce in the present embodiment) (see FIG. 2(a)). Typically, the Ce concentration of a YAG:Ce phosphor that is commercially available often uses a concentration of high light emission efficiency in a case of being used at room temperature (for example, approximately from 1.4 to 1.5 mol %). This is because in a YAG phosphor with a low concentration of Ce, the internal quantum efficiency increases, but the absorption rate of the excitation light is low, the external quantum efficiency, which is important as a wavelength conversion element, is the optimal value near the Ce concentration of 1.5 mol %. In a case where the phosphor temperature of the irradiation spot is in a region exceeding 250° C. by excitation light irradiation of high energy density and high intensity, the light emission efficiency decreases in a typical YAG:Ce phosphor (Ce concentration of 1.4 mol %). Herein, a YAG:Ce phosphor with a low Ce concentration (for example, approximately from 0.5 to 1.0 mol %) is considered in more detail. Referring to FIG. 2(a), it can be seen that, when the Ce concentration is larger than or equal to 1.0 mol %, a decrease in luminance can be seen at an irradiation energy density being equal to or larger than 10 W/mm². In contrast, when the Ce concentration is approximately 0.5 to 0.7 mol %, a decrease in luminance cannot be seen until the irradiation energy density comes to approximately 16 W/mm². With this, it may be understood that a phosphor having unfavorable temperature characteristics is caused to have a high temperature by the excitation light and decreases the luminance thereof, when the Ce concentration is larger than or equal to 1.0 mol %.

FIG. 2(b) depicts temperature dependency of phosphor layers with different thicknesses. In any case, a phosphor with a Ce concentration of 0.7 mol % and an average particle diameter D50 of 11.1 μm is used as a sample. When the thickness of the phosphor layer is 20 μm to 40 μm, a decrease in luminance cannot be seen until the irradiation energy density comes to at least about 16 W/mm². In contrast, when the thickness of the phosphor layer is 70 μm, a decrease in luminance is seen at the irradiation energy density being equal to or larger than 12 W/mm². When the thickness of the phosphor layer is 100 μm, a significant decrease in luminance is seen at the irradiation energy density being equal to or larger than 5.5 W/mm². When the phosphor layer is thick, it may be seen that the heat dissipation toward the substrate is not carried out quickly enough, so that the surface temperature rises to decrease the luminance.

In any case, the peak intensity decreases as the energy density of the irradiation light [W/mm²] increases, and therefore it is necessary to consider an aspect in which the energy density of the irradiation light (also referred to herein as the irradiation energy density) [W/mm²] is not increased. Hereinafter, the present invention will be described in each embodiment in consideration of the circumstances described above.

### First Embodiment

### Configuration of Optical Element

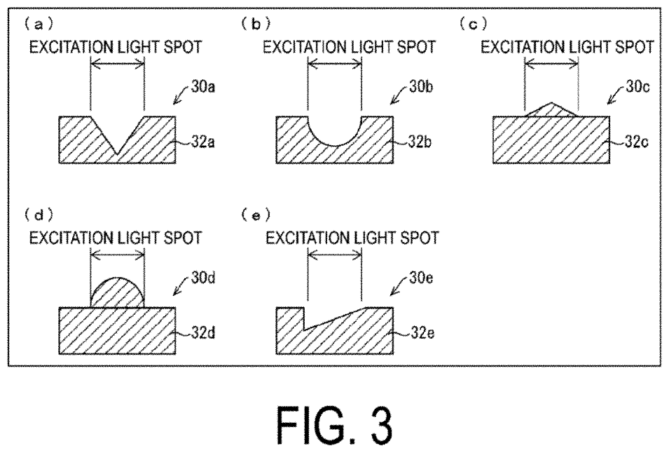

An embodiment of the present invention will be described in detail below. FIGS. 3(a) to (e) illustrate schematic diagrams of optical elements 30a to 30e, respectively, according to a first embodiment of the present invention. The configuration of the present embodiment differs from the configuration of the general wavelength conversion element 10 illustrated in FIG. 1 in that the phosphor layer 12 is configured in a different manner. The optical elements 30a to 30e according to the first embodiment are achieved by performing recess-projection forming processing on phosphor layers 32a to 32e corresponding to the phosphor layer 12 deposited on the substrate 11 in FIG. 1.

A surface of each of the phosphor layers 32a to 32e to be irradiated with the excitation light 14 has preferably experienced recess-projection forming processing in and around a region of the surface to be spot-irradiated with the excitation light. In a preferred embodiment, the recess-projection forming processing may be performed on a wider region than the spot irradiation region. By the recess-projection forming processing, the surface area of the spot irradiation region of the excitation light is increased. In another preferred embodiment, a region smaller than the spot irradiation region may be subjected to the recess-projection forming processing. In this case, it is preferable that, of the regions to be spot-irradiated, a region having experienced the recess-projection forming processing (a first region) be not parallel to a region not having experienced the recess-projection forming processing (a second region). The region not having experienced the recess-projection forming processing (the second region) has the same shape as the surface of the phosphor layer 12 in FIG. 1, and is generally perpendicular to a propagation direction (traveling direction) of the excitation light 14. Accordingly, it is preferable that the region having experienced the recess-projection forming processing (the first region) have an angle that is not perpendicular to the propagation direction (traveling direction) of the excitation light 14. The non-perpendicular angle means that the processed surface is inclined with respect to the propagation direction (traveling direction) of the excitation light 14 in a case where the recess-projection forming processing produces a triangular shape as described below. In a case where the recess-projection forming processing produces a curved surface such as a circular shape, the non-perpendicular angle means that the processed surface has a curved surface with respect to the propagation direction (traveling direction) of the excitation light 14.

In a case where the region not having experienced the recess-projection forming processing (the second region) is not perpendicular to the propagation direction (traveling direction) of the excitation light 14, that is, when the excitation light irradiation is carried out at an inclined angle, it is preferable that the processed surface experience the recess-projection forming processing to have a more largely inclined angle with respect to the propagation direction (traveling direction) of the excitation light 14. Even when the excitation light is irradiated at an inclined angle, the surface area does not increase in a case where the region (second region) that has not experienced the recess-projection forming processing is parallel to the region (first region) that has experienced the recess-projection forming processing. For this reason, it is preferable that the second region and the first region be not parallel to each other, and that the processed surface be formed to have an inclined angle that is not perpendicular to the propagation direction (traveling direction) of the excitation light 14.

Since the irradiation energy density [W/mm²] is power of light per unit area, the larger the irradiation area is, the smaller the irradiation energy density [W/mm²] is, as long as the power is of the same amount of light. As described above, the surface area of the spot irradiation region of the excitation light increases and the irradiation energy density [W/mm²] becomes smaller by performing the recess-projection forming processing on each of the phosphor layers 32a to 32e.

The processed surface on which the recess-projection forming processing is performed in order to increase the surface area of the spot irradiation region of the excitation light, is preferably processed at an angle that is not perpendicular to the propagation direction (traveling direction) of the excitation light. In a case where the processed surface is perpendicular to the propagation direction (traveling direction), the surface area does not increase, and therefore, as the angle obtained by the processing is larger, the surface area increases and the effect becomes higher.

As in the optical element 30a illustrated in FIG. 3(a), it is preferable that a recess having an inverted isosceles triangle shape be provided on the surface of the phosphor layer 32a. It is also preferable to provide a recess having a semicircular shape on the surface of the phosphor layer 32b as in the optical element 30b illustrated in FIG. 3(b). In another preferred embodiment, it is also possible to provide a recess having an inverted triangle shape on the surface of the phosphor layer 32e as in the optical element 30e illustrated in FIG. 3(e). The inverted triangle for forming the recess is not limited to an isosceles triangle as in the optical element 30a. The forming processing of the above-described recesses may be carried out by using stampers of various shapes after having deposited the phosphor layers 32a, 32b, and 32e. In a recess-projection pattern such as a triangular shape, it is preferable to perform recess-projection forming processing at an inclined angle (non-perpendicular angle) with respect to the propagation direction (traveling direction) of the excitation light.

On the other hand, a triangular-shaped projection may be provided on the surface of the phosphor layer 32c as in the optical element 30c illustrated in FIG. 3(c). In another preferred embodiment, a semicircular-shaped projection may be provided on the surface of the phosphor layer 32d as in the optical element 30d illustrated in FIG. 3(d). In a case of a recess-projection pattern that is not a straight line such as a semicircular shape, as the curvature thereof is larger, the effect is higher because the surface area is increased compared to the same irradiation cross-sectional area before the processing. In a case of a recess-projection pattern such as a semicircular shape, it is preferable to perform recess-projection forming processing to form a shape including a curved surface with respect to the propagation direction (traveling direction) of the excitation light.

The phosphor layers 32a to 32e are each preferably formed of a Ce doped YAG phosphor layer.

### Second Embodiment

Another embodiment of the present invention will be described below. Note that, for convenience of explanation, components having the same function as those described in the above-described embodiments will be denoted by the same reference signs, and descriptions of those components will be omitted.

### Configuration of Optical Element

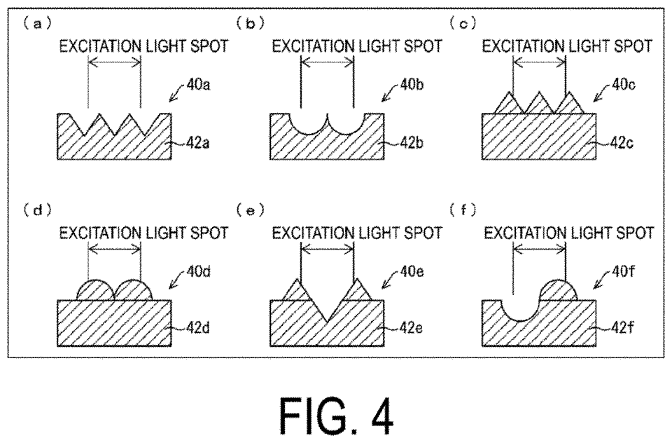

As in an optical element 40a illustrated in FIG. 4(a), it is preferable to provide a plurality of recesses each having an inverted isosceles triangle shape on the surface of a phosphor layer 42a. It is also preferable to provide a plurality of recesses each having a semicircular shape on the surface of a phosphor layer 42b as in an optical element 40b illustrated in FIG. 4(b). The inverted triangle for forming the recess is not limited to an isosceles triangle as in the optical element 40a. The forming processing of the above-described recesses may be carried out by using stampers of various shapes after having deposited the phosphor layers 42a and 42b.

On the other hand, a plurality of triangular-shaped projections may be provided on the surface of a phosphor layer 42c as in an optical element 40c illustrated in FIG. 4(c). In another preferred embodiment, a plurality of semicircular-shaped projections may be provided on the surface of a phosphor layer 42d as in an optical element 40d illustrated in FIG. 4(d).

Further, as in an optical element 40e illustrated in FIG. 4(e), a plurality of triangular-shaped projections and a triangular-shaped recess may be provided on the surface of a phosphor layer 42e. In another preferred embodiment, a semicircular-shaped recess and a semicircular-shaped projection may be provided on the surface of a phosphor layer 42f as in an optical element 40f illustrated in FIG. 4(f). A plurality of these recesses and projections may also be provided.

### Third Embodiment

Another embodiment of the present invention will be described below. Note that, for convenience of explanation, components having the same function as those described in the above-described embodiments will be denoted by the same reference signs, and descriptions of those components will be omitted.

### Configuration of Optical Element

As described in the second and third embodiments, a larger surface area irradiated with excitation light by the excitation light spot is able to reduce irradiation energy density. Therefore, as long as the recess-projection form is the same, it is preferable to increase the depth of the recess and the height of the projection because the surface area is increased by doing so.

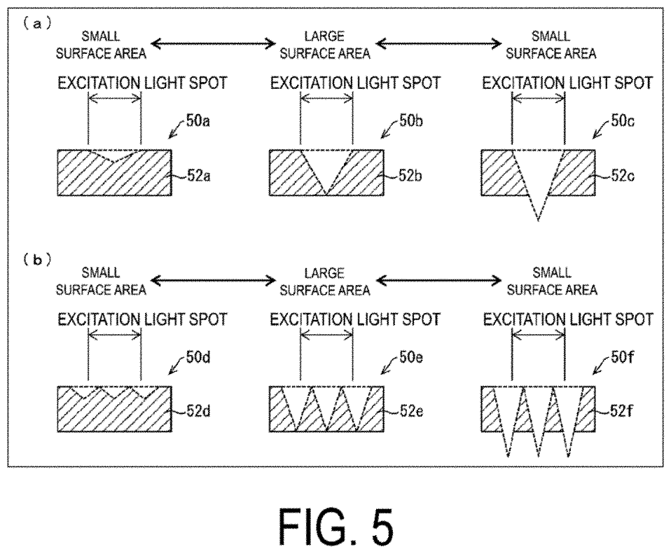

FIG. 5(a) schematically illustrates a difference in surface area of a recess formed by a single inverted triangle corresponding to FIG. 3(a). When the depth of the inverted triangle is shallow (optical element 50a), the surface area of a recess of a phosphor layer 52a is small. When the inverted triangle has a depth equivalent to the thickness of a phosphor layer 52b (optical element 50b), the surface area of the recess becomes largest. However, when the depth is equal to the thickness of the phosphor layer 52b, the phosphor layer 52b is not present at the bottommost portion of the recess, and thus the light emission efficiency is lowered. It is preferable that the depth of the recess be such a depth that allows the phosphor layer to reside at the bottommost portion of the recess in order to prevent the reduction in light emission efficiency from occurring. When the depth of the inverted triangle exceeds the thickness of a phosphor layer 52c (optical element 50c), the surface area of the phosphor layer 52c to be irradiated with the excitation light becomes smaller than that of the phosphor layer 52b of the optical element 50b.

FIG. 5(b) schematically illustrates a difference in surface area of recesses formed by a plurality of inverted triangles corresponding to FIG. 4(a). Similarly to FIG. 5(a), the surface area of a phosphor layer 52d in an optical element 50d is smallest, and the surface area of a phosphor layer 52e in an optical element 50e is largest. In an optical element 50f, the surface area of a phosphor layer 52f is smaller than the surface area of the phosphor layer 52e in the optical element 50e. In the case of the optical element 50e, it is preferable that the depth of the recess be such a depth that allows the phosphor layer 52e to reside at the bottommost portion of the recess in order to prevent the reduction in light emission efficiency from occurring.

### Fourth Embodiment

Another embodiment of the present invention will be described below. Note that, for convenience of explanation, components having the same function as those described in the above-described embodiments will be denoted by the same reference signs, and descriptions of those components will be omitted.

### Excitation Light Profile

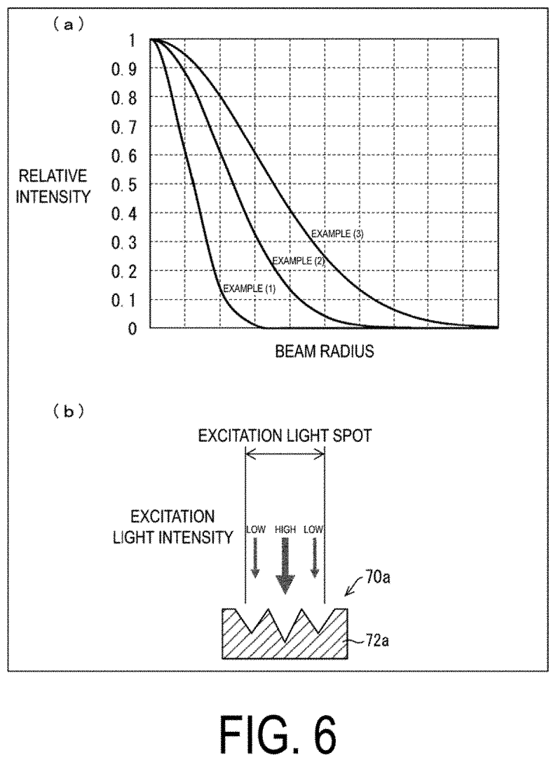

FIG. 6(a) is a graph depicting relative intensity over a beam radius of an excitation light spot. As indicated by the graph in FIG. 6(a), the excitation light has the highest intensity at the center of the spot and decreases in intensity as going toward a side away from the center. The intensity distribution of the excitation light is preferably Gaussian distribution. When the intensity distribution of the excitation light takes Gaussian distribution, a spot radius of a Gaussian beam (Gaussian beam radius:ω₀) is defined as a value of 1/e² of the peak value.

FIG. 6(b) illustrates an aspect in which the intensity differs depending on a location of the excitation light spot. Since the intensity is highest at a center portion of the excitation light spot, in a case where three recesses each having an inverted triangle shape are formed on a phosphor layer 72a as in an optical elements 70a, it is preferable to deepen the depth of the inverted triangle-shaped recess located at the center.

In a preferred embodiment, a region extending within a range of the radius until the intensity of the excitation light spot is halved can be defined as a center portion of the excitation light, and a region other than the above-described region can be defined as a peripheral portion of the excitation light. When the intensity distribution of the excitation light takes Gaussian distribution, the radius of the region forming the center portion of the excitation light is approximately 0.59ω₀ (={(√(In2))/(√2)}×ω₀). A region on the outer side of a location approximately 0.59ω₀ away from the center of the excitation light may be referred to as the peripheral portion of the excitation light. The center portion and peripheral portion of the excitation light may be optionally set, without being limited to the above-described embodiments. For example, a region extending up to the radius of 0.23ω₀, at which the intensity of the excitation light is decreased by 10% of the peak value, may be referred to as the center portion of the excitation light, and a region on the outer side of a location 0.23ω₀ away from the center of the excitation light may be referred to as the peripheral portion of the excitation light.

### Configuration of Optical Element

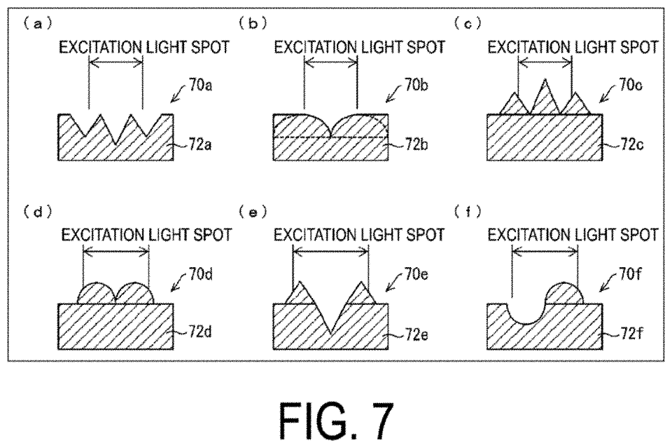

FIG. 7 illustrates recesses and projections formed in phosphor layers configured in consideration of intensity distribution of excitation light spots. FIG. 7(a) illustrates the optical element 70a provided with recesses in the phosphor layer 72a described above. FIG. 7(c) illustrates an optical element 70c in which a phosphor layer 72c is provided with projections having a shape equivalent to a shape obtained by vertically inverting the shape formed in the optical element 70a. In the projections, it is preferable to increase the height of the center triangle because the intensity at the center portion of the spot is high. In an aspect using a semicircular projection, an optical element 70b including a phosphor layer 72b illustrated in FIG. 7(b), an optical element 70d including a phosphor layer 72d illustrated in FIG. 7(d), or the like is preferable. In any case, an aspect in which the surface area becomes large at the center portion of the spot where the intensity is high is preferable. In an aspect in which recesses and projections are combined, an optical element 70e including a phosphor layer 72e illustrated in FIG. 7(e), an optical element 70f including a phosphor layer 72f illustrated in FIG. 7(f), or the like is preferable. In any case, an aspect in which the surface area becomes large at the center portion of the spot where the intensity is high is preferable.

### Manufacturing Process for Wavelength Conversion Element

As the substrate 11 of the wavelength conversion element used in the above-described first to fourth embodiments, an aluminum substrate may be used. In order to increase the fluorescent light emission intensity, a highly reflective ill m such as silver is preferably coated on the aluminum substrate. In other embodiments, highly reflective alumina substrates, white fill scattering substrates, etc. may be used. The material of the substrate 11 preferably has a high thermal conductivity such as metal, and is not particularly limited to the materials described above.

A Ce doped YAG phosphor layer is applied onto the substrate 11. The manufacturing method is not limited to sedimentation application, and other methods may be used. As an example of a yellow phosphor doped with Ce in YAG, a YAG phosphor with a Ce concentration of 1.4 mol % may be applied. In a preferred embodiment, the phosphor layer may have a thickness of about 50 μm to 150 μm.

### Fifth Embodiment

Another embodiment of the present invention will be described below. Note that, for convenience of explanation, components having the same function as those described in the above-described embodiments will be denoted by the same reference signs, and descriptions of those components will be omitted.

### Configuration of Reflection-Type Vehicle Headlight

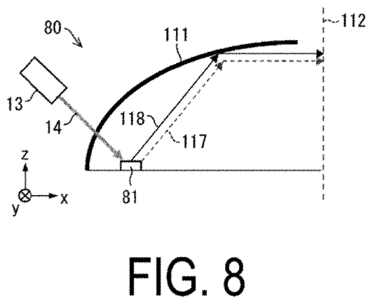

FIG. 8 illustrates a schematic diagram of a light source device 80 according to a fifth embodiment of the present invention. The light source device 80 is preferably a reflection-type laser headlight (vehicle headlight). An excitation light source 13 is preferably a blue laser source configured to emit excitation light 14 having a wavelength for exciting a phosphor layer of a wavelength conversion element 81. A reflector 111 is preferably constituted by a semi-paraboloid mirror. A paraboloid is vertically divided, in parallel to an xy plane, into two parts to obtain a semi-paraboloid, and the inner surface thereof is preferably a mirror. There is a hole in the reflector 111 through which the excitation light 14 passes. The wavelength conversion element 81 is excited by the blue excitation light 14, and causes light in a long wavelength region of visible light (yellow wavelength) to be a fluorescent light emission 117. The excitation light 14 also becomes diffuse reflected light 118 by striking against the wavelength conversion element 81. The wavelength conversion element 81 is disposed at a focal point of the paraboloid. Since the wavelength conversion element 81 is disposed at the focal point of the paraboloid mirror, when the fluorescent light emission 117 emitted from the wavelength conversion element 81 and the diffuse reflected light 118 strike against and reflect off the reflector 111, they uniformly travel in a straight line to a light emission face 112. White light that is mixed with the fluorescent light emission 117 and the diffuse reflected light 118 exits from the light emission face 112 as parallel light.

In the fifth embodiment, as the phosphor layer of the wavelength conversion element 81, any of the phosphor layers 32a to 32e of the first embodiment, the phosphor layers 42a to 42f of the second embodiment, the phosphor layers 52b and 52e of the third embodiment, and the phosphor layers 72a to 72f of the fourth embodiment may be employed.

### Sixth Embodiment

Another embodiment of the present invention will be described below. Note that, for convenience of explanation, components having the same function as those described in the above-described embodiments will be denoted by the same reference signs, and descriptions of those components will be omitted.

### Configuration of Transmission-Type Vehicle Headlight

In a sixth embodiment of the present invention, it is preferable to provide a transmission-type light source device configured to irradiate excitation light 14 from the lower side of a transmissive substrate 71. It is also preferable that the transmissive substrate 71 have heat sink structure. In another preferred embodiment, the transmissive substrate 71 may be cooled by fixedly making contact with a transmissive heat sink (not illustrated).

A phosphor layer 91 is preferably deposited on the lower side (irradiation surface side) of the transmissive substrate 71. When the excitation light 14 is irradiated onto the phosphor 91, fluorescent light is emitted from the opposite side of the transmissive substrate 71, and the light reflected by a reflector 111 is emitted through a light emission face 90 as parallel beams.

Such light source device is preferably mounted on a transmission-type laser headlight (vehicle headlight) (PTL 2 (WO 2014/203484)). As disclosed in PTL 3 (JP 2012-119193 A), in a case where a fluorescent film is deposited on a transmissive heat sink substrate, it is known that the heat sink side exhibits high heat dissipation when excitation light enters from the heat sink side.

In the sixth embodiment, as the phosphor layer 91, any of the phosphor layers 32a to 32e of the first embodiment, the phosphor layers 42a to 42f of the second embodiment, the phosphor layers 52b and 52e of the third embodiment, and the phosphor layers 72a to 72f of the fourth embodiment may be employed.

### Seventh Embodiment

Another embodiment of the present invention will be described below. Note that, for convenience of explanation, components having the same function as those described in the above-described embodiments will be denoted by the same reference signs, and descriptions of those components will be omitted.

### Configuration of Light Source Module

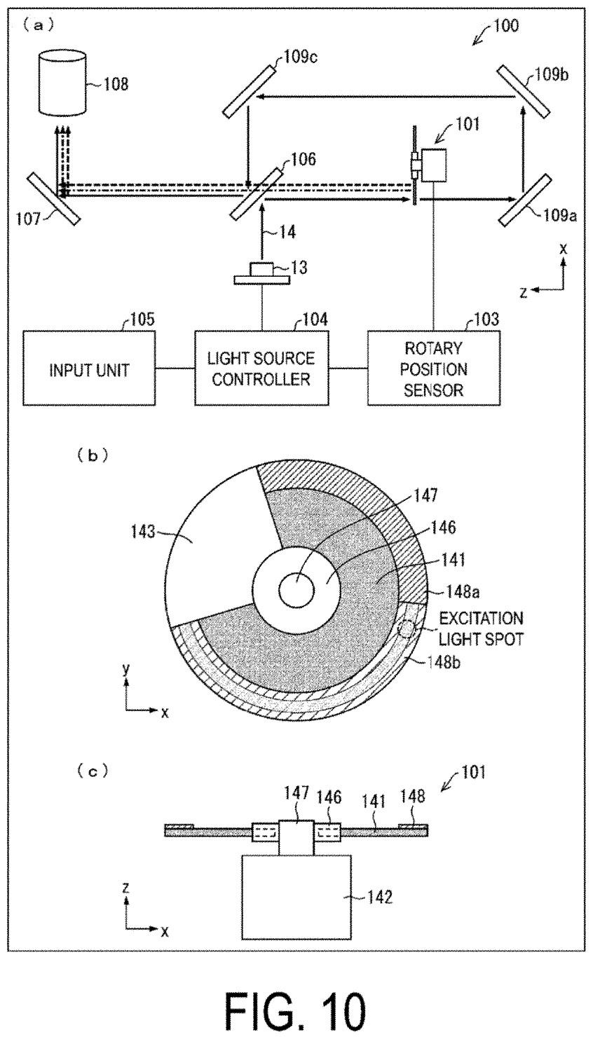

A light source module 101 illustrated in FIG. 10(c) may be preferably used in a projector or the like. In the light source module 101, the excitation light source 13 is preferably a blue laser source configured to emit the excitation light 14 having a wavelength for exciting a phosphor layer 148. In a preferred embodiment, a blue laser diode that excites a phosphor such as YAG, LuAG or the like is used.

The phosphor layer 148 is deposited on a fluorescent wheel 141. FIG. 10(b) illustrates a plan view (xy plane) of the fluorescent wheel 141. In a preferred embodiment, the phosphor layer 148 is deposited on the peripheral portion of the surface of the fluorescent wheel 141. The fluorescent wheel 141 is fixed to a rotation shaft 147 of a drive device 142 by a wheel fixture 146. The drive device 142 is preferably a motor, and the fluorescent wheel 141, which is fixed with the fixture 146 to the rotation shaft 147 as the rotating shaft of the motor, rotates with the rotation of the motor.

The phosphor layer 148 deposited on the peripheral portion on the surface of the fluorescent wheel 141 receives excitation light and emits fluorescent light. The phosphor layer 148 emits the fluorescent light while rotating at any time due to the rotation accompanying the rotation of the fluorescent wheel 141.

When excitation is performed in a state where the external quantum efficiency of the phosphor is low, there arises a problem that fluorescent light emission is weak with respect to the excitation light and the balance of color is worsened. In order to avoid this situation, an adjustment scheme is conceivable in which the excitation light is attenuated by a filter, the output is reduced by time division, or the like, but such scheme is not preferable because the brightness is reduced. To resolve the above-described problem, by dividing the fluorescent wheel into a plurality of segments in a circumferential direction and separately applying the phosphors for each segment, it is possible to maintain a high level of external quantum efficiency. This makes it possible to create a variety of colors while maintaining brightness.

FIG. 10(b) is a schematic diagram illustrating an aspect in which the fluorescent wheel 141 is divided into a plurality of segments, and a plurality of different phosphor layers 148 are deposited for each segment on at least a portion in the circumferential direction through which the excitation light passes. In a preferred embodiment, by being irradiated with an excitation light 14, a phosphor layer 148a preferably fluoresces with a wavelength corresponding to red color, and a phosphor layer 148b fluoresces with a wavelength corresponding to green color. It is preferable that the fluorescent wheel 141 normally reflect the excitation light 14, but some of the segments may be made to be a transmissive portion 143, through which the excitation light 14 passes. In a preferred embodiment, the transmissive portion 143 is preferably made of glass. By employing the above-described segment configuration, it is possible to convert the excitation light 14 into a plurality of wavelengths with one fluorescent wheel.

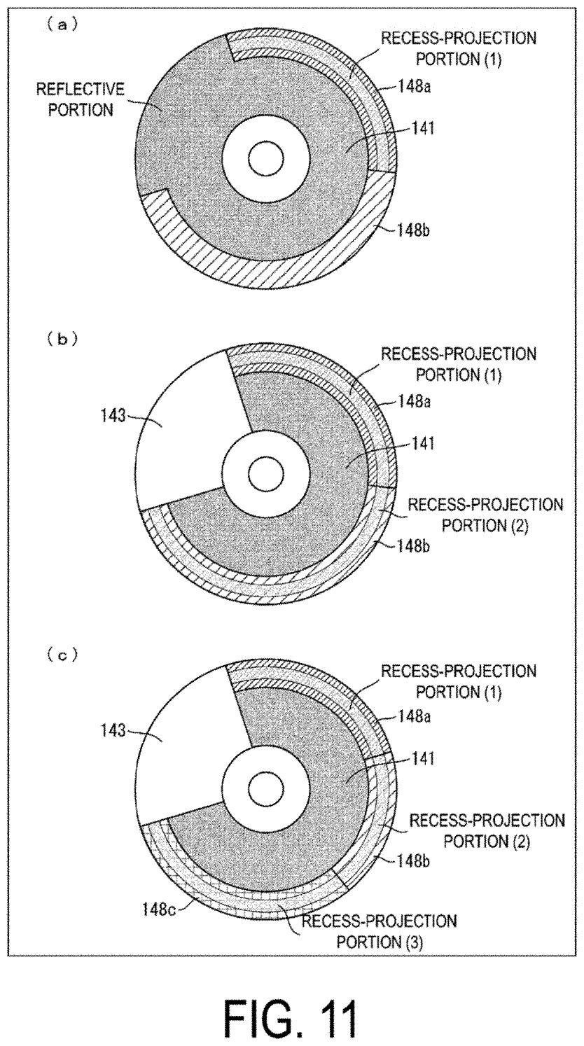

Another preferred embodiment is illustrated in FIG. 11. FIG. 11(a) illustrates a configuration in which the segment made to be the transmissive portion 143 in FIG. 10(b) is made to be a reflective portion. Furthermore, in the segment to which the phosphor layer 148a is applied, it is preferable to provide a recess-projection portion 1 on the phosphor layer 148a. In a preferred embodiment, it is preferable that a cross-sectional shape in an xz plane of the phosphor layer 148a be a recess-projection portion, and that the recess-projection portion 1 be formed continuously in the circumferential direction. The phosphor layer 148a may employ any of the phosphor layers 32a to 32e of the first embodiment, the phosphor layers 42a to 42f of the second embodiment, the phosphor layers 52b and 52e of the third embodiment, and the phosphor layers 72a to 72f of the fourth embodiment.

FIG. 11(b) illustrates a configuration in which the segment made to be the reflective portion in FIG. 10(a) is made to be the transmissive portion 143. Furthermore, in the segment to which the phosphor layer 148b is applied, it is preferable to provide a recess-projection portion 2 on the phosphor layer 148b. As in the phosphor 148a in FIG. 11(a), in a preferred embodiment, it is preferable that a cross-sectional shape in the xz plane of the phosphor layer 148b be a recess-projection portion, and that the recess-projection portion 2 be formed continuously in the circumferential direction. The phosphor layer 148b may employ any of the phosphor layers 32a to 32e of the first embodiment, the phosphor layers 42a to 42f of the second embodiment, the phosphor layers 52b and 52e of the third embodiment, and the phosphor layers 72a to 72f of the fourth embodiment.

FIG. 11(c) illustrates a fluorescent wheel provided with still another segment. On the still another segment, a phosphor layer 148c is preferably deposited. It is preferable that the phosphor layer 148c fluoresce with a wavelength corresponding to yellow color by being irradiated with the excitation light 14. As in the phosphor 148a in FIG. 11(a), in a preferred embodiment, it is preferable that a cross-sectional shape in the xz plane of the phosphor layer 148c be a recess-projection portion, and that a recess-projection portion 3 be formed continuously in the circumferential direction. The phosphor layer 148c may employ any of the phosphor layers 32a to 32e of the first embodiment, the phosphor layers 42a to 42f of the second embodiment, the phosphor layers 52b and 52e of the third embodiment, and the phosphor layers 72a to 72f of the fourth embodiment.

### Configuration of Projection Device

In FIG. 10(a), a schematic diagram of a projection device 100 using the light source module 101 according to the seventh embodiment is illustrated.

In a case where the transmissive portion 143 is provided in some of the segments of the fluorescent wheel 141 (see FIG. 11(b)), the excitation light 14 of blue light emission passes through the fluorescent wheel 141 via the transmissive portion 143. The excitation light 14, with which the phosphor layer 148 is irradiated, may pass through a light source-side optical system 106 and mirrors 109a to 109c on an optical path. The light source-side optical system 106 is preferably a dichroic mirror. A preferred dichroic mirror may reflect blue light incident thereon at 45 degrees, and may allow red light and green light to pass therethrough.

To be more specific, by employing a dichroic mirror having the above-described optical characteristics for the light source-side optical system 106, blue light by the excitation light 14 incident on the dichroic mirror is reflected and directed to the fluorescent wheel 141. In accordance with the timing of rotation of the fluorescent wheel 141, blue light passes through the fluorescent wheel 141 via the transmissive portion 143. In accordance with timing of rotation of the fluorescent wheel 141, the excitation light 14 irradiated onto the segments other than the transmissive portion 143 causes fluorescent light to be emitted by irradiating the phosphor layer 148. For each segment, the fluorescent light of the red wavelength band is emitted in the phosphor layer 148a, and the fluorescent light of the green wavelength band is emitted in the phosphor layer 148b. The fluorescence-emitted red and green light passes through the dichroic mirror and is incident on a display element 107. The blue light having passed through the transmissive portion 143 is incident again on the dichroic mirror via the mirrors 109a to 109c, and is reflected again by the dichroic mirror to be incident on the display element 107.

In a preferred embodiment, the projector (projection device 100) may include the light source module 101, the display element 107, the light source-side optical system 106 (dichroic mirror), and a projection-side optical system 108. The light source-side optical system 106 (dichroic mirror) may guide the light from the light source module 101 to the display element 107, and the projection-side optical system 108 may project projection light from the display element 107 onto a screen or the like. In a preferred embodiment, the display element 107 is preferably a digital mirror device (DMD). The projection-side optical system 108 preferably includes a combination of projection lenses.

### Supplement

An optical element (30a to 30e, 40a to 40f, 50a to 50f, 70a to 70f) according to a first aspect of the present invention includes a phosphor layer (32a to 32e, 42a to 42f, 52a to 52f, 72a to 72f, 91, 148, 148a, 148b, 148c) configured to emit fluorescent light by being excited by excitation light (14) emitted from a light source (13). The phosphor layer (32a to 32e, 42a to 42f, 52a to 52f, 72a to 72f, 91, 148, 148a, 148b, 148c) has a first surface to be irradiated with the excitation light (14), an excitation light irradiation region of the first surface includes a first region and a second region, the first region is processed beforehand to be set at an angle that is not perpendicular to a propagation direction of the excitation light, and the first region and the second region are configured to be non-parallel to each other.

According to the above-discussed configuration, in comparison with a case where the phosphor surface is flat, the irradiation energy density decreases due to an increase in irradiation area of the irradiation region, and thus a drop in light emission efficiency due to the excitation energy density dependency can be prevented.

An optical element (30a to 30e, 40a to 40f, 50a to 50f, 70a to 70f) according to a second aspect of the present invention may be configured such that, in the first aspect, the first region is constituted by forming at least one recess or more on the first surface, and the depth of the recess is smaller in length than the thickness of the phosphor layer (32a to 32e, 42a to 42f, 52a to 52f, 72a to 72f, 91, 148, 148a, 148b, 148c).

According to the above-described configuration, the phosphor also exists in the bottom portion of the recess-processed region for increasing the irradiation area, thereby making it possible to prevent a drop in light emission efficiency from occurring.

An optical element according to a third aspect of the present invention may be configured such that, in the first or second aspect, the first region is constituted by forming at least one projection on the first surface.

According to the above-described configuration, by combining recesses and projections in accordance with a mode of an excitation light irradiation spot, it is possible to increase the irradiation area of the irradiation region and prevent the drop in light emission efficiency from occurring.

An optical element (70a to 70f) according to a fourth aspect of the present invention may be configured such that, in any one of the first to third aspects, an irradiation area of the first region irradiated with a peripheral portion of the excitation light is smaller than an irradiation area of the first region irradiated with a center portion of the excitation light.

According to the above-described configuration, it is possible to change the irradiation area of the irradiation region in accordance with an intensity profile of the excitation light irradiation spot, and prevent the drop in light emission efficiency from occurring.

A vehicle headlight device (80) according to a fifth aspect of the present invention includes the optical element (30a to 30e, 40a to 40f, 50a to 50f, 70a to 70f) according to any one of the first to fourth aspects, a light source (13) configured to irradiate excitation light (14) onto the optical element (30a to 30e, 40a to 40f, 50a to 50f, 70a to 70f), and a reflector (111) including a reflective surface configured to reflect fluorescent light emitted from the optical element (30a to 30e, 40a to 40f, 50a to 50f, 70a to 70f). The reflective surface of the reflector (111) may have a shape configured to reflect incident light in such a manner that the reflected light is emitted in parallel in a fixed direction.

A vehicle headlight device according to a sixth aspect of the present invention includes the optical element (30a to 30e, 40a to 40f, 50a to 50f, 70a to 70f) according to any one of the first to fourth aspects, a light source (13) configured to irradiate excitation light (14) onto the optical element (30a to 30e, 40a to 40f, 50a to 50f, 70a to 70f), and a transmissive substrate (71). The phosphor layer (91) may have a second surface opposing the first surface, the optical element (30a to 30e, 40a to 40f, 50a to 50f, 70a to 70f) may be disposed in such a manner that the second surface faces the transmissive substrate (71), the excitation light (14) may be irradiated from the first surface of the phosphor layer (91), and fluorescent light may be emitted from the second surface through the transmissive substrate (71).

A light source device (101) according to a seventh aspect of the present invention may be configured to include, in any one of the first to fourth aspects, a light source (13) configured to emit excitation light (14); a fluorescent wheel (141), on which the optical element (30a to 30e, 40a to 40f, 50a to 50f, 70a to 70f) according to any one of the first to fourth aspects is disposed in at least a portion in a circumferential direction through which the excitation light (14) emitted from the light source (13) passes; and a drive device (142) configured to rotate the fluorescent wheel (141). The phosphor layer (148, 148a, 148b, 148c) may have a second surface opposing the first surface, and may be disposed on the fluorescent wheel (141) in such a manner that the second surface of the phosphor layer (148, 148a, 148b, 148c) faces a surface of the fluorescent wheel (141). A first region of the optical element (30a to 30e, 40a to 40f, 50a to 50f, 70a to 70f) may be formed in an annular shape in the circumferential direction of the fluorescent wheel (141). Fluorescent light may be emitted in a case where the excitation light (14) is incident on at least the first region of the optical element (30a to 30e, 40a to 40f, 50a to 50f, 70a to 70f) accompanying rotation of the fluorescent wheel (141).

A projection device according to an eighth aspect of the present invention includes the light source device (101) according to the seventh aspect, a display element (107), a light source-side optical system (106) configured to guide light from the light source device (101) to the display element, and a projection-side optical system (108) configured to project projection light from the display element (107) onto a screen or the like.

A projection device according to a ninth aspect of the present invention may be configured to include: the light source device (101) according to the seventh aspect provided with a fluorescent wheel (141), on which the optical elements (30a to 30e, 40a to 40f, 50a to 50f, 70a to 70f) according to any one of the first to fourth aspects are divided into a plurality of segments in a circumferential direction and disposed in at least a portion in the circumferential direction through which excitation light (14) emitted from a light source (13) passes; a rotary position sensor (103) configured to acquire a rotary position of the fluorescent wheel (141); a light source controller (104) configured to control the light source based on output information from the rotary position sensor (103); a display element (107); a light source-side optical system (106) configured to guide light from the light source device (101) to the display element (107); and a projection-side optical system (108) configured to project projection light from the display element (107) onto a screen or the like, The output of the light source (13) may be controlled based on rotary position information of the fluorescent wheel (141) acquired by the rotary position sensor (103).

The present invention is not limited to each of the above-described embodiments. It is possible to make various modifications within the scope of the claims. An embodiment obtained by appropriately combining technical elements each disclosed in different embodiments also falls within the technical scope of the present invention. Furthermore, technical elements disclosed in the respective embodiments may be combined to provide a new technical feature.

1. An optical element comprising:
a phosphor layer configured to emit fluorescent light by being excited by excitation light emitted from a light source,
wherein the phosphor layer has a first surface to be irradiated with the excitation light,
an excitation light irradiation region of the first surface includes a first region and a second region,
the first region is processed beforehand to be set at an angle that is not perpendicular to a propagation direction of the excitation light, and
the first region and the second region are non-parallel to each other.

2. The optical element according to claim 1,
wherein the first region is constituted by forming at least one recess on the first surface, and
a depth of the recess is smaller in length than a thickness of the phosphor layer.

3. The optical element according to claim 1,
wherein the first region is constituted by forming at least one projection on the first surface.

4. The optical element according to claim 1,
wherein an irradiation area of the first region irradiated with a peripheral portion of the excitation light is smaller than an irradiation area of the first region irradiated with a center portion of the excitation light.

5. A vehicle headlight device comprising:
the optical element according to claim 1;
a light source configured to irradiate excitation light onto the optical element; and
a reflector including a reflective surface configured to reflect fluorescent light emitted from the optical element,
wherein the reflective surface of the reflector has a shape configured to reflect incident light and the reflected light is emitted in parallel in a fixed direction.

6. A vehicle headlight device comprising:
the optical element according to claim 1;
a light source configured to irradiate excitation light onto the optical element; and
a transmissive substrate,
wherein the phosphor layer has a second surface opposing the first surface,
the optical element is disposed in such a manner that the second surface faces the transmissive substrate, and
the excitation light is irradiated from the first surface of the phosphor layer, and fluorescent light is emitted from the second surface through the transmissive substrate.

7. A light source device comprising:
a light source configured to emit excitation light;
a fluorescent wheel, on which the optical element according to claim 1 is disposed in at least a portion in a circumferential direction through which the excitation light emitted from the light source passes; and
a drive device configured to rotate the fluorescent wheel,
wherein the phosphor layer has a second surface opposing the first surface, and is disposed on the fluorescent wheel in such a manner that the second surface of the phosphor layer faces a surface of the fluorescent wheel,
a first region of the optical element is formed in an annular shape in the circumferential direction of the fluorescent wheel, and
fluorescent light is emitted in a case that the excitation light is incident on at least the first region of the optical element accompanying rotation of the fluorescent wheel.

8. A projection device comprising:
the light source device according to claim 7;
a display element;
a light source-side optical system configured to guide light from the light source device to the display element; and
a projection-side optical system configured to project projection light from the display element onto a screen or the like.

9. A projection device comprising:
the light source device according to claim 7;
a rotary position sensor configured to acquire a rotary position of the fluorescent wheel;
a light source controller configured to control the light source based on output information from the rotary position sensor;
a display element;
a light source-side optical system configured to guide light from the light source device to the display element; and
a projection-side optical system configured to project projection light from the display element onto a screen or the like,
wherein output of the light source is controlled based on rotary position information of the fluorescent wheel acquired by the rotary position sensor.
